(19) United States
(12) Patent Application Publication
(10) Pub. No.: US 2010/0120402 A1
(43) Pub. Date: May 13, 2010

(54) System and Method for Enhanced Content Access

(75) Inventors: Ramandeep Sethi, Fremont, CA (US); Thomas Whittaker, Wanda, MN (US); Bill Clagett, Elizabethtown, KY (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Reston, VA (US)

(21) Appl. No.: 12/502,327

(22) Filed: Jul. 14, 2009

Related U.S. Application Data
(60) Provisional application No. 61/080,422, filed on Jul. 14, 2008.

(51) Int. Cl. H04M 3/42

(52) U.S. Cl. 455/414.1

(57) ABSTRACT

As Mobile Subscribers increasingly employ their Wireless Devices to access an ever expanding universe of content—anything including but not limited to for example WWW pages, JavaScript, ActiveX, static images, audio, video, streaming audio/video, data, software applications, etc.—an infrastructure that supports seamless access to content by addressing a range of challenges that arise during such interactions including, for example, the proper identification of content, the timely retrieval of content from a variety of sources, the processing and persistence of content, the delivery of content, etc. The infrastructure may optionally leverage the capabilities of a centrally-located Messaging Inter-Carrier Vendor.

This application claims the benefit of U.S. Provisional Patent Application Ser. No. 61/080,422, filed on 14 Jul. 2008, which is herein incorporated by reference in its entirety.

### BACKGROUND

1. Field of the Invention

The present invention relates generally to telecommunications services. More particularly, the present invention relates to capabilities that enhance substantially the ability of Wireless Devices (WDs) to access content (for example among other things pages on the World Wide Web [WWW]).

2. Background of the Invention

As the ‘wireless revolution’ continues to march forward the importance to a Mobile Subscriber (MS)—for example a user of a WD such as possibly inter alia a mobile telephone, a BlackBerry, a Personal Digital Assistant (PDA), a handheld computer, etc. that is serviced in some way by a Wireless Carrier (WC)—of their WD grows substantially.

One consequence of such a growing importance is the resulting ubiquitous nature of WDs—i.e., MSs carry them at almost all times and use them for an ever-increasing range of activities.

One of the activities for which MSs are increasingly using their WDs is accessing content—including but not limited to for example WWW pages (in the form of, possibly inter alia, HyperText Markup Language [HTML] documents), JavaScript, ActiveX, static images (in the form of, possibly inter alia, Joint Photographic Experts Group [JPEG] objects, Graphics Interchange Format [GIF] objects, Portable Network Graphics [PNG] objects, etc.), audio (in the form of, possibly inter alia, MPEG-1 Audio Layer 3 [MP3] objects, Vorbis objects, Waveform Audio Format [WAV] objects, etc.), video (in the form of, possibly inter alia, MPEG-1 [MPG] objects, Audio Video Interleave [AVI] objects, etc.), streaming audio/video, data (in the form of, possibly inter alia, Extensible Markup Language [XML] documents, etc.), software applications, etc.—frequently via a web browser on their WD.

Several examples, out of the many possible examples that will be obvious to one or ordinary skill in the art, may help to illustrate:

1) Many WCs establish and maintain around their infrastructure what are commonly referred to as ‘walled gardens,’ allowing in only those specific products, services, applications, etc. that a WC wishes to offer to their MSs and keeping out everything else (much of which a WC's MSs may in fact wish to patronize). Consequently it can be difficult for an application developer or provider to get their new WD Operating System (OS)-based mobile application approved by a WC and inside the WC's ‘walled garden’ so that the WC's MSs can partake of the application on their WDs. However, when an application developer or provider deploys their solution as a Web-based application, instead of for example as a native WD OS-based mobile application, then a MS may partake of the application simply by accessing the application over the WWW via a generic browser on their WD.

2) Application developers and providers are increasingly turning to paradigms such as Software as a Service (SAAS) to deliver their applications over the WWW. Such applications may be accessed via for example a WD browser.

3) Many forms of media (including inter alia books, magazines, newspapers, movies, video clips, songs, etc.) are delivered or are otherwise available over the WWW. Such media may be accessed via for example a WD browser.

A MS accessing content via their WD raises a number of infrastructure, etc. challenges. The challenges include possibly inter alia the identification of content, the timely retrieval of content, the processing of content, etc. An additional challenge arises (vis-à-vis a MS' user experience) when a MS' WD state transitions from online (e.g., in communication with a WC's infrastructure and able to exchange information) to offline (e.g., not online).

It would be advantageous to have an infrastructure that supports possibly inter alia enhanced content access including for example seamless access to content regardless of WD state.

The present invention facilitates such enhanced content access and addresses various of the (not insubstantial) challenges that are associated with same.

### SUMMARY OF THE INVENTION

One embodiment of the present invention offers a method for accessing content that includes possibly inter alia (1) receiving an indication of required content from a WD of a MS; (2) performing one or more processing steps—using (a) aspects of the indication of required content and (b) information about the MS—to (a) retrieve content from one or more internal and/or external sources, (b) process aspects of the retrieved content, including transforming links or references present in the retrieved content using Globally Unique Content Identifier (GUCIDs)s, (c) persist aspects of the processed content; and (3) delivering aspects of the persisted content to the WD.

Another embodiment of the present invention offers a system for accessing content that includes possibly inter alia (1) a gateway at which an indication of required content is received, the indication of required content having originated from a WD of a MS and (2) one or more workflow modules that (a) perform one or more processing steps—using (i) aspects of the indication of required content and (ii) information about the mobile subscriber—to (i) retrieve content from one or more internal and/or external sources, (ii) process aspects of the retrieved content, including transforming links or references present in the retrieved content using GUCIDs, and (iii) persist aspects of the processed content and (b) deliver aspects of the persisted content to the WD.

These and other features of the embodiments of the present invention, along with their attendant advantages, will be more fully appreciated upon a reading of the following detailed description in conjunction with the associated drawings.

### BRIEF DESCRIPTION OF THE DRAWINGS

The accompanying drawings, which are incorporated herein and form part of the specification, depict embodiments of the present invention and, together with the summary that was presented above and the description that may be found below, further serve to illustrate inter alia the principles, structure, and operation of such embodiments. It will be readily apparent to one of ordinary skill in the relevant art that numerous variations, modifications, alternative forms, etc. of the depicted embodiments are easily possible and indeed are within the scope of the present invention.

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are possible during an optional registration portion of the present invention.

FIG. 4 is a diagrammatic presentation of aspects of an exemplary Service Provider (SP) Application Server (AS).

FIG. 5 illustrates various of the exchanges or interactions that may arise during aspects of a content retrieval portion of the present invention.

FIG. 6 illustrates several of the link, reference, etc. transformations that are possible under aspects of the present invention.

FIG. 7 is a diagrammatic presentation of a portion of an exemplary WD in accordance with aspects of the present invention.

FIG. 8 depicts an exemplary ‘integer triple’ list that is possible under aspects of the present invention.

### DETAILED DESCRIPTION

At a high level aspects of the present invention allow a MS to use their WD to seamlessly and transparently access content regardless of their WD's state (i.e., online [e.g., in communication with a WC's infrastructure and able to exchange information] or offline [e.g., not online]).

Aspects of the present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same.

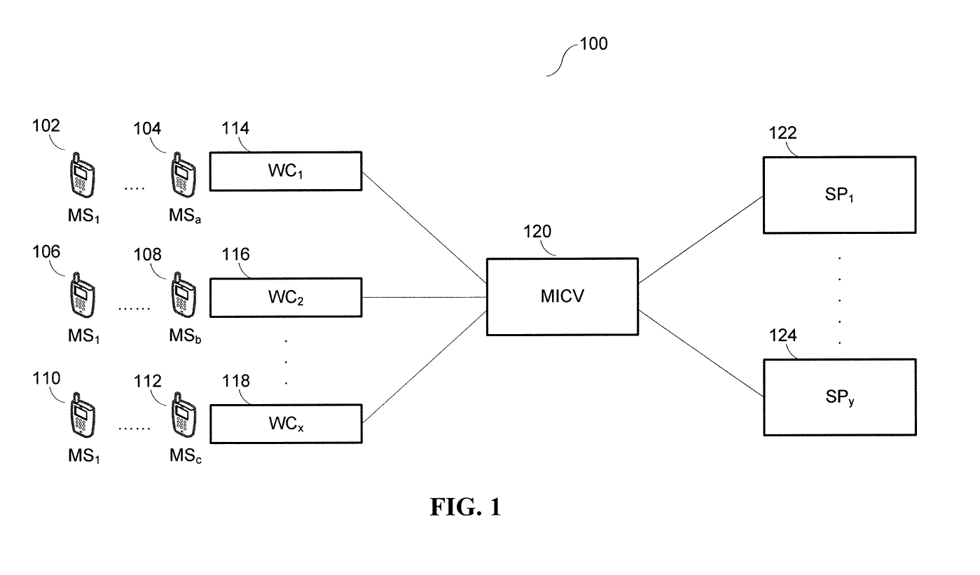

As illustrated in FIG. 1 and reference numeral 100 a MICV 120 is disposed between, possibly inter alia, multiple WCs (WC₁ 114, WC₂ 116,→WCₓ 118) on one side and multiple SPs (SP₁ 122→SP_{y}124) on the other side and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, 110→112 that are serviced by the WC 114→118) with ubiquitous access to a broad universe of SPs 122→124, and

2) A SP 122→124 with ubiquitous access to a broad universe of WCs 114→118 (and, by extension, to all of the MSs 102→104, 106→108, 110→112 that are serviced by the WCs 114→118).

Generally speaking a MICV may have varying degrees of visibility (e.g., access, etc.) to the (MS ←→MS, MS←→SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV, it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a service that has been enhanced or augmented as provided through aspects of the instant invention and Mary, a MS, uses SPₓ's service.

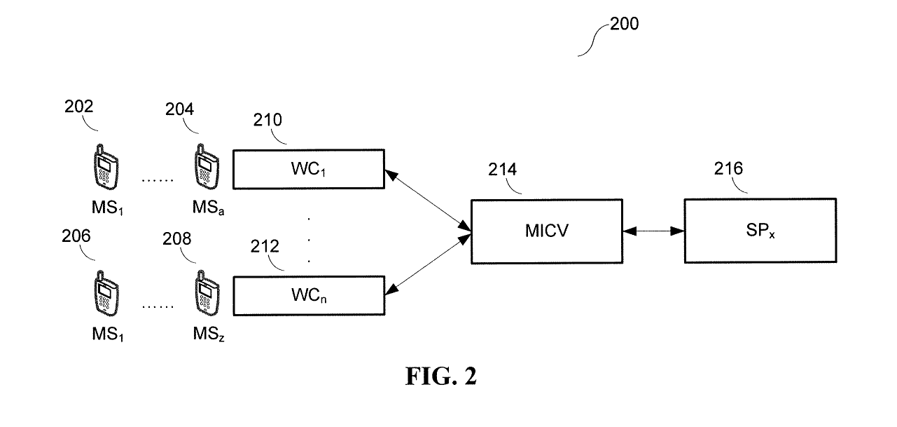

FIG. 2 and reference numeral 200 depict one particular arrangement that may be possible under our hypothetical example. As the diagram portrays, the messaging traffic of numerous MSs (MS₁ 202→MSₐ 204 and MS₁ 206→MS_{z} 208, including Mary) serviced by WC₁ 210→WCₙ212 is exchanged with a MICV 214 and the MICV 214 is connected with SP_{X} 216 (a SP that offers, possibly inter alia, aspects of the present invention).

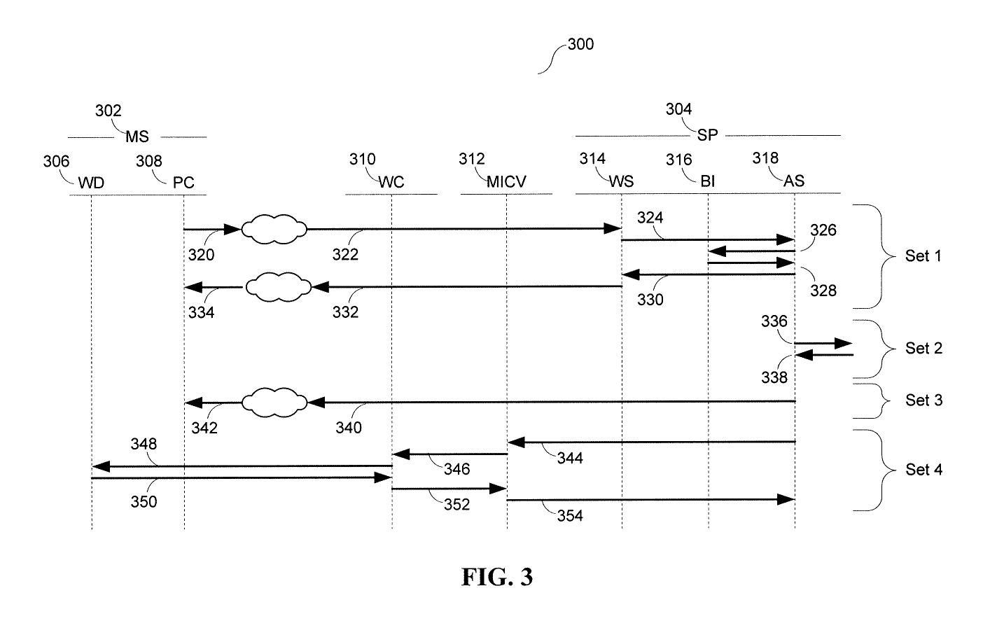

FIG. 3 and reference numeral 300 illustrate various of the exchanges or interactions that might occur under an optional registration portion of our hypothetical example. A registration process may be tailored (e.g., the range of information gathered, the scope of access subsequently granted, etc.) to the class of user—e.g., different types, categories, etc. of users may complete different registration processes. Of interest and note in the diagram are the following entities:

MS 302 WD 306. For example, Mary's WD such as mobile telephone, BlackBerry, PalmPilot, etc.

MS 302 Personal Computer (PC) 308. For example, one of Mary's 302 home, work, etc. PCs.

WC 310. The provider of service for Mary's 302 WD 306.

MICV 312. As noted above the use of a MICV, although not required, provides significant advantages.

SP 304 Web Server (WS) 314. A publicly-available Web site that is optionally provided by SPₓ 304.

SP 304 Billing Interface (BI) 316. A single, consolidated interface that SP_{X} 304 may use to easily reach, inter alia, one or more external entities such as a credit card or debit card clearinghouse, a carrier billing system, a service bureau that provides access to multiple carrier billing systems, etc.

SP 304 AS 318. Facilities that provide key elements of the instant invention (which will be described below).

It is important to note that while in FIG. 3 the MS 302 WD 306 and MS 302 PC 308 entities are illustrated as being adjacent or otherwise near each other, in actual practice the entities may, for example, be physically located anywhere.

In FIG. 3 the exchanges that are collected under the designation Set 1 represent the activities that might take place as Mary 302 completes a registration process with SP_{X} 304:

A) Mary 302 uses one of her PCs 308 to visit SPₓ's 304 WS 314 to, possibly among other things, complete a service registration process (320→322).

B) SPₓ's 304 WS 314 interacts with SPₓ's 304 AS 318 to, possibly among other things, commit some or all of the information that Mary 302 provided to a data repository (e.g., a database), optionally complete a billing transaction, etc. (324).

C) As appropriate and as required a BI 316 completes a billing transaction (326→328).

D) Following a reply from SPₓ's 304 AS 318 (330) SPₓ's 304 WS 314 responds appropriately (e.g., with the presentation of a confirmation message, etc.) (332→334).

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms. For example, the registration process may be completed through any combination of one or more channels including, inter alia, the WWW (via, for example, a Web site that is operated by SPₓ), wireless messaging (Short Message Service [SMS], Multimedia Message Service [MMS], etc.), Electronic Mail (E-Mail) messages, Instant Messaging (IM), conventional mail, telephone, Interactive Voice Response (IVR) facility, etc.

During the registration process described above a range of information may be captured from a MS including, inter alia:

A) Identifying Information. For example, possibly among other things, name, address, landline and wireless Telephone Numbers (TNs), E-Mail addresses, IM names/identifiers, a unique identifier and a password, etc.

B) Preference Information. For example, information on possibly inter alia specific pieces of content that are of interest to the MS; information about the types, etc. of content that are generally of interest to the MS; etc. For example, for each piece of content that is identified possibly inter alia attributes such as name; location (e.g., a Uniform Resource Locator [URL], etc.); access credentials (e.g., user identifier and password); publication or syndication details; etc.

C) Billing Information. Different service billing models may be offered including, inter alia, a fixed one-time charge, a recurring (monthly, etc.) fixed charge, a recurring (monthly, etc.) variable charge, etc. Different payment mechanisms may be supported including, possibly among other things, credit or debit card information, authorization to place a charge on a MS's phone bill, etc.

D) Other Information. Additional, possibly optional, information.

The specific pieces of information that were described above are illustrative only and it will be readily apparent to one of ordinary skill in the relevant art that numerous other pieces of information (e.g., additional Preference Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may be augmented by SPₓ to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

3) The generation of an invoice.

In FIG. 3 the exchanges that are collected under the designation Set 2 represent the activities that might take place as SPₓ's 304 AS 318 interacts with one or more external entities (to possibly inter alia confirm access, register to receive updates, etc.) (336→338).

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 3 the exchanges that are collected under the designation Set 3 represent the activities that might take place as SPₓ's 304 AS 318 dispatches to Mary 302 one or more confirmation E-Mail messages (340→342).

The specific exchanges that were described above (as residing under the designation Set 3) are illustrative only and it will be readily apparent to one of ordinary skill in the relevant art that numerous other exchanges are easily possible and indeed are fully within the scope of the present invention.

In FIG. 3 the exchanges that are collected under the designation Set 4 represent the activities that might take place as SPₓ's 304 AS 318 dispatches one or more confirmation SMS, MMS, etc. messages to Mary's 302 WD 306 (344→348) and Mary 302 optionally replies or responds to the message(s) (350→354).

In the instant example the messages are shown traversing a MICV 312.

The SP 304 may employ a Short Code (SC) or a regular TN as its source address (and to which it would ask users of its service to direct any reply messages). While the abbreviated length of a SC (e.g., five digits for a SC administered by Neustar under the Common Short Code [CSC] program) incrementally enhances the experience of a MS 302 (e.g., the MS 302 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The specific exchanges that were described above (as residing under the designation Set 4) are illustrative only and it will be readily apparent to one of ordinary skill in the relevant art that numerous other exchanges are easily possible (e.g., the messaging sequence 344→348 and/or 350→354 may be repeated any number of times, etc.) and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention. For example, possibly inter alia, the registration information that was described above may subsequently be managed (e.g., existing information may be edited or removed, new information may be added, etc.) through any combination of one or more channels including, inter alia, a SP's WWW facility, wireless messaging (SMS, MMS, IMS, etc.), E-Mail messages, IM exchanges, conventional mail, telephone, IVR facilities, etc.

To continue with our hypothetical example . . . following completion of an optional registration process indications may be accumulated (as described below) of specific pieces of content that Mary (our hypothetical MS) may wish to peruse, navigate, etc. on her WD. Armed with these indications a SP may possibly inter alia complete any number of tasks to for example retrieve aspects of the indicated content, process aspects of the retrieved content, persist aspects of the processed content, etc. including for example:

1) Retrieval. A SP may issues requests for, and receive responses back containing, content from any combination of any number of internal sources (such as for example caches, repositories, etc.) and/or any number of external sources (such as for example the WWW, extranets, intranets, File Transfer Protocol [FTP] sites, commercial repositories, etc.). A SP may optionally manage the contents of its internal sources through mechanisms such as aging models, periodic refresh, etc.

2) Processing. A SP may optionally process aspects of the received content. Such processing may leverage possibly inter alia bodies of flexible, extensible, and dynamically updatable (a) configuration information and (b) rules.

3) Persistence. A SP may optionally preserve aspects of the received and/or processed content in one or more internal repositories (including possibly among other mechanisms databases, file systems, data structures, etc.).

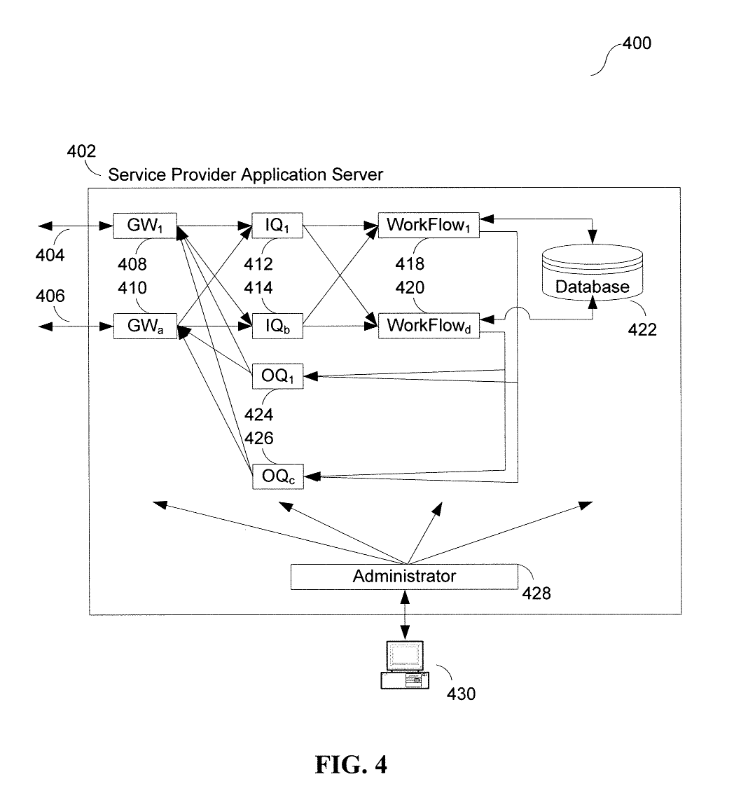

FIG. 4 and reference numeral 400 provide a diagrammatic presentation of aspects of an exemplary SP AS 402 which may physically realize among other things various of the tasks that were described above. The illustrated AS 402 contains several key components—Gateways (GW₁ 408→GWₐ 410 in the diagram), Incoming Queues (IQ₁' 412→IQ_{b} 414 in the diagram), WorkFlows (WorkFlow₁ 418 →WorkFlow_{d} 420 in the diagram), Database 422, Outgoing Queues (OQ₁ 424→OQ_{c} 426 in the diagram), and an Administrator 428. It will be readily apparent to one of ordinary skill in the relevant art that (a) numerous other components and/or (b) numerous alternative component arrangements are possible within an AS 402.

A dynamically updateable set of one or more Gateways (GW₁ 408→GWₐ 410 in the diagram) handle incoming traffic (e.g., registration, requested content, etc.) (404→406) and outgoing traffic (e.g., requests for content such as possibly inter alia HyperText Transfer Protocol [HTTP] GET methods, confirmation during a registration process, etc.) (404→406).

A dynamically updateable set of one or more Incoming Queues (IQ₁412→IQ_{b} 414 in the diagram) and a dynamically updateable set of one or more Outgoing Queues (OQ₁ 424→OQ_{c} 426 in the diagram) operate as intermediate or temporary buffers for incoming and outgoing traffic (404→406). Incoming traffic (404→406) is accepted and deposited on an intermediate or temporary Incoming Queue (IQ₁ 412→IQ_{b} 414 in the diagram) for subsequent processing. Processed artifacts are removed from an intermediate or temporary Outgoing Queue (OQ₁ 424→OQ_{c} 426 in the diagram) and then dispatched (404→406).

A dynamically updateable set of one or more WorkFlows (WorkFlow₁ 418→WorkFlow_{d} 420 in the diagram) remove incoming traffic from an intermediate or temporary Incoming Queue (IQ₁ 412→IQ_{b} 414 in the diagram), perform all of the required processing operations, and deposit processed artifacts on an intermediate or temporary Outgoing Queue (OQ₁ 424→OQ_{c} 426 in the diagram). The WorkFlow component will be described more fully below.

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 428 that is depicted in FIG. 4 provides management or administrative control over all of the different components of an AS 402 through, as one example, a Web-based interface 430. It will be readily apparent to one of ordinary skill in the relevant art that numerous other interfaces (e.g., an Application Programming Interface [API], a data feed, etc.) are easily possible.

Through flexible, extensible, and dynamically updatable configuration information a WorkFlow component may be quickly and easily realized to support any number of activities. For example, WorkFlows might be configured to support possibly inter alia:

1) Aspects of a registration process (e.g., as described above).

2) The generation and dispatch of confirmation, response, etc. messages.

3) Various billing transactions.

4) The generation of scheduled and/or on-demand reports. Such reports may be viewed through any number of mechanisms including possibly inter alia simple displays; Geographic Information Systems (GISs); visualization facilities; etc. and delivered through any number of mechanisms including possibly inter alia SMS, MMS, etc. messaging; E-Mail; IM; a WWW-based facility; etc.

5) The identification of content. As described further below, through various mechanisms (including possibly inter alia the application of predictive analysis [leveraging for example a dynamically configurable suite of rules or logic] to the Preference element of a MS' profile, based on schedules within the Preference element of a MS' profile, from a list of content needed [based for example on a MS′ perusal/navigation/etc. of content on their WD], etc.) a range of needed/likely-to-be-needed/etc. content may be identified.

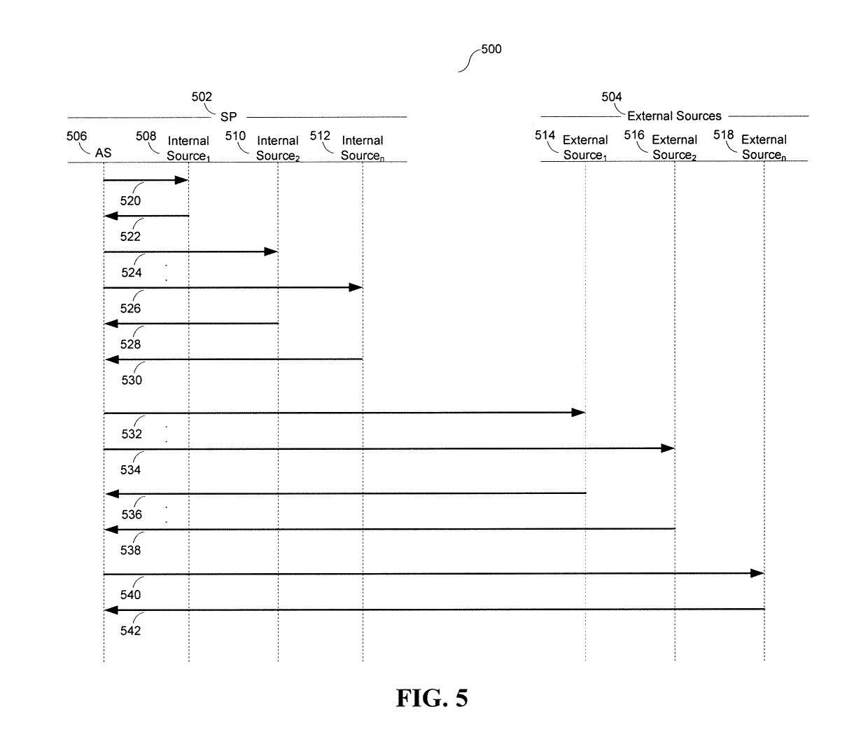

6) The retrieval of content. This may involve possibly inter alia the issuance of any number of any combination of synchronous and/or asynchronous (a) HTTP GET methods (to for example secure one or more pages from a Web-based resource, ‘spider’ a web-based resource [where parameters such as breadth, depth, etc. may be dynamically controlled], etc.), (b) database or other repository queries (to for example retrieve one or more records, objects, etc. from such a repository), (c) file and other artifact ‘read’ commands (to for example retrieve one or more records, etc. from such a repository), etc. FIG. 5 and reference numeral 500 provide a diagrammatic presentation of aspects of an exemplary content retrieval sequence (involving among other things an AS 506 of a SP 502, various sources 508→512 that are internal to the SP 502, and various sources 514→518 that are external 504 to the SP 502) (520 →542).

7) The processing and the persistence of content. As indicated above, the processing of content may leverage possibly inter alia bodies of flexible, extensible, and dynamically updatable (a) configuration information and (b) rules and the persistence of content may involve one or more internal repositories (including possibly among other mechanisms databases, file systems, data structures, etc.).

8) The delivery of content to a WD (discussed below).

The specific WorkFlows that were just described are exemplary only. It will be readily apparent to one of ordinary skill in the relevant art that numerous other WorkFlow arrangements, alternatives, etc. are easily possible.

A SP may maintain a repository (e.g., a database) into which selected details of all administrative, transaction, messaging, etc. activities may be recorded. Among other things, such a repository may be used to support scheduled (e.g., daily, weekly, etc.) and/or on-demand reporting with report results delivered (to, for example, a MS) through SMS, MMS, etc. messages; through E-Mail; through IM; through a Web-based facility; etc.

Under one embodiment of aspects of the present invention a SP may during one or more of the tasks that were described above transform various of the links, references, navigational directives, etc. that may be present in the content. Among other things a transformation may reduce the complexity of such links/references/etc., shift the orientation of such links/references/etc. from an external (e.g., the WWW) to an internal frame of reference, etc.

For example, during manipulation of a HTML document a SP may replace the URL component of a HyperText Reference (HREF) with:

1) An internally-assigned and managed GUCID. The SP may optionally retain the original link, reference, etc. within its environment. A GUCID may take any number of forms including possibly inter alia a large (e.g., a 64-bit or a 128-bit) number, a coded sequence of letters and numbers, etc.

2) An internally-assigned and managed hierarchical construct that may for example extend or descend from a Local System (LS) entry point.

3) Various other internally-assigned and managed constructs.

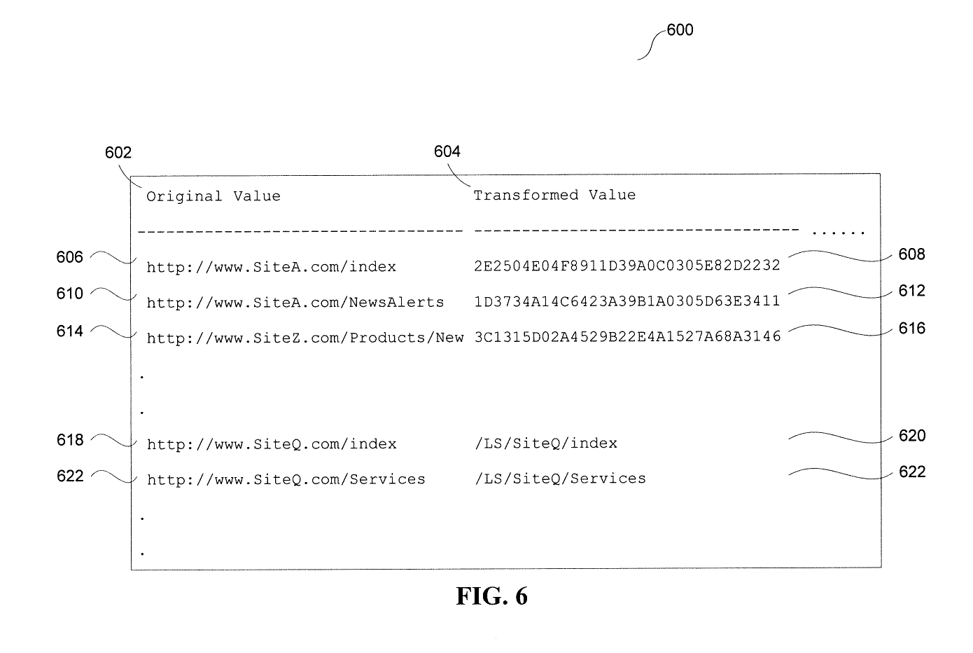

FIG. 6 and reference numeral 600 depict a number of exemplary transformations (showing an original value 602 and a transformed value 604 and including among other things several GUCID values 606/610/614→608/612/616 and several LS-based values 618/622→620/622).

Equivalent replacements may take place for other HTML elements such as for example SRC, ACTION, etc.

Under one embodiment of aspects of the present invention a SP may during one or more of the tasks that were described above generate an ‘integer triple’ for each item (e.g., link, reference, etc.) of interest, each integer triple containing:

1) A pre-defined set of type indicators (e.g., constants).

2) The index of the beginning of the item of interest within the piece of content.

3) The index of the end of the item of interest within the piece of content.

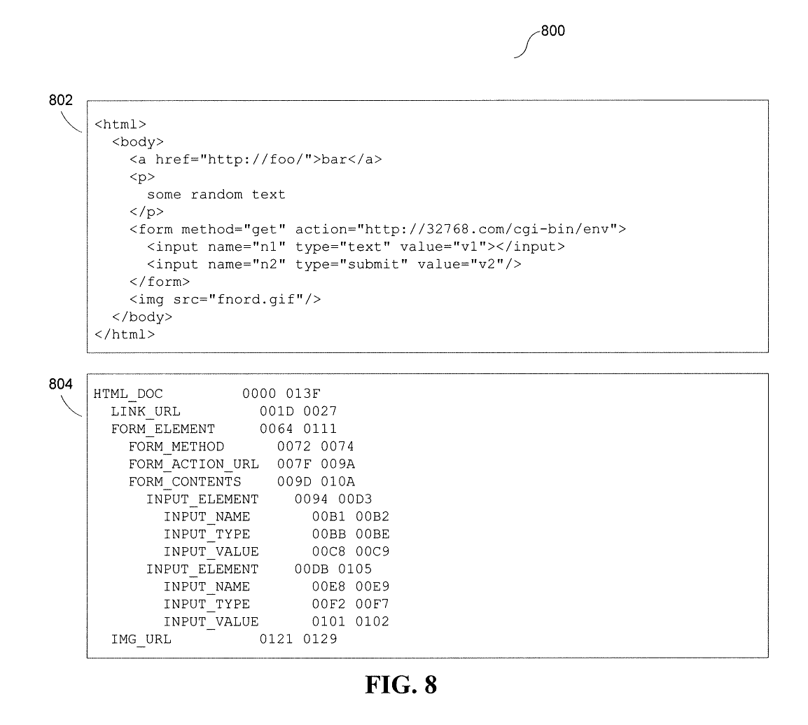

and an accumulated list of integer triples efficiently defining (at least the important, relevant, etc. portions of) the piece of content. FIG. 8 and reference numeral 800 provide an example of a hypothetical HTML document 802 and a resulting list of integer triples 804 (indented for clarity).

Aspects of the present invention may offer a synchronization operation (synchronizing) whereby possibly inter alia information may be transferred between a WD and a SP's server environment. For example:

1) Under one embodiment synchronizing can be defined as mirroring data on a WD and a SP's server environment, such that the data is the same on the WD and within the SP's server environment. Under other embodiments synchronizing can be defined as overwriting data on a WD or on a SP's server environment such that (1) the data on the WD replaces the data within the SP's server environment or (2) the data within the SP's server environment replaces the data on the WD.

2) During synchronization a variety of information may be transferred from a SP's server environment (including for example retrieved/processed/persisted content, optionally aspects of a SP's link/reference transformation table, etc.) to a WD in any number of ways including possibly inter alia as individual pieces, as a single (final form, near final form, etc.) ‘image,’ etc.

3) During synchronization a variety of information may be transferred from a WD (including possibly inter alia a list of content needed and a resource visited list [both discussed below]) to a SP's server environment in any number of ways including possibly inter alia as individual pieces, as a single (final form, near final form, etc.) ‘image,’ etc. Following such a transfer a SP may complete any number of processing activities including possibly inter alia adding aspects of a resource visited list to portions of a MS' profile (to for example continuously expand, refresh, etc. the Preference portion of a MS' profile).

4) Synchronizing may be initiated through any combination of automatic (e.g., when a MS' WD transitions from an offline state to an online state) and/or manual (e.g., at the direction of a WD's MS) mechanisms and may incorporate one or more wired (e.g., docking cradle, Universal Serial Bus [USB] cable, etc.) and/or wireless (e.g., Bluetooth, Near Field Communication [NFC], SMS/MMS/etc. messaging, infrared, etc.) technologies.

5) Synchronizing may include the use of periodic checkpoints to enable possibly inter alia a selective roll-back capability (e.g., in the case of error, etc.).

6) Synchronizing may include one or more encryption/decryption capabilities to enhance security.

7) Synchronizing may include one or more compression/decompression capabilities to reduce the volume of information that need be exchanged.

8) Synchronizing may include one or more mechanisms (including for example parity schemes, checksums, Cyclic Redundancy Checks [CRCs], etc.) for error detection and/or correction purposes.

9) During synchronization a SP may optionally complete one or more billing transactions.

To further illustrate the sorts of activities that may occur during a synchronization operation consider the following hypothetical example:

Point 1) Based on various mechanisms (including possibly inter alia the application of predictive analysis [employing for example a suite of dynamically configurable rules or logic] to the Preference element of Mary's profile, based on schedules within the Preference element of a MS' profile, from a list of content needed [based for example on a MS' previous perusal/navigation/etc. of content on their WD], etc.) a SP may identify a range of content that it subsequently retrieves, processes, and persists.

Point 2) Asynchronously Mary employs her WD to peruse, navigate, etc. content (more about this below) yielding among other things a list of content needed and a resource visited list.

Point 3) During a synchronization operation among other things (a) a SP may transfer various information (including for example retrieved/processed/persisted content, optionally aspects of a SP's link/reference transformation table, etc.) from its server environment to Mary's WD (at which point, as described below, aspects of the information may be optionally processed and then persisted within one or more repositories on the WD) and (b) Mary's WD may transfer various information (including possibly inter alia a list of content needed and a resource visited list) from its environment to a SP (at which point the SP may for example complete a series of internal tasks [including possibly inter alia updating aspects of Mary's profile] and then return to Point 1 above).

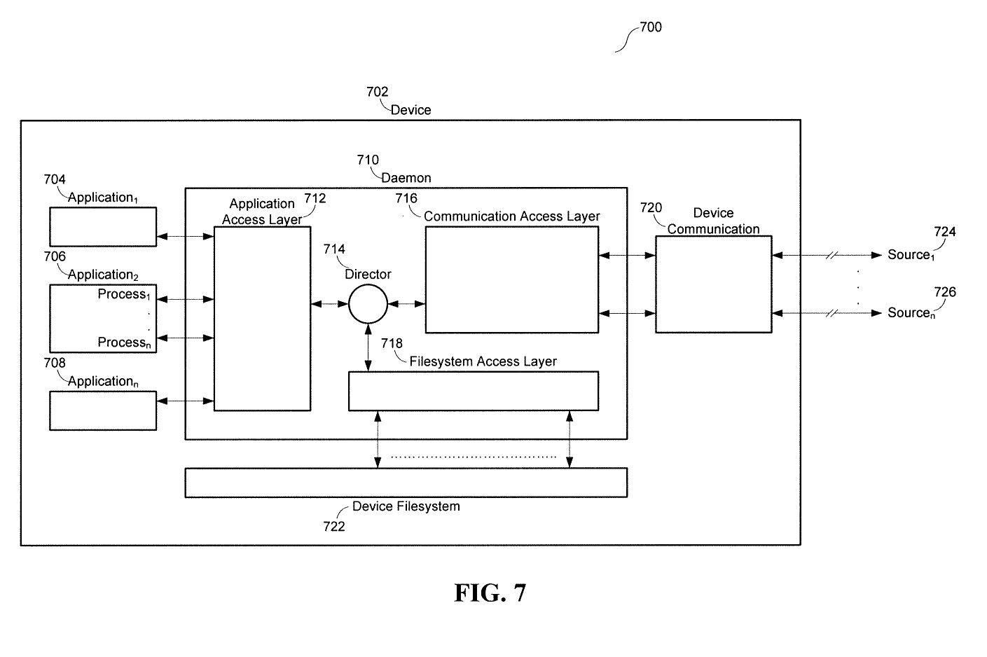

FIG. 7 and reference numeral 700 depict a portion of an exemplary WD arrangement that is possible under one embodiment of aspects of the present invention. It is important to note that the indicated arrangement is illustrative only and it will be readily apparent to one of ordinary skill in the relevant art that numerous other arrangements, as well as numerous other elements each with many potential arrangements, are easily possible and indeed are fully within the scope of the present invention.

Of interest and note in FIG. 7 and reference numeral 700 are the following elements:

1. Device 702. A WD such as possibly inter alia a mobile telephone, a BlackBerry, a PDA, a handheld computer, etc.

2. Applications 704→708. Software applications such as possibly inter alia a WWW browser (such as for example Internet Explorer, Opera, etc.), a thick or thin client, etc. Such applications 704→708 may be organized in a variety of ways including possibly inter alia as a monolithic entity, with one or more internal processes or threads of execution, etc.

3. Daemon 710. A collection of components that realize aspects of the present invention. The instant exemplary arrangement identifies four key components—an Application Access Layer 712, a Director 714, a Communication Access Layer 716, and a Filesystem Access Layer 718—which are described more fully below. It will be readily apparent to one of ordinary skill in the relevant art that alternative arrangements, as well as numerous other components with many potential arrangements, are easily possible and indeed are fully within the scope of the present invention.

4. Application Access Layer 712. A single consolidated façade through which applications 704→708 may possibly inter alia communicate to among other things (a) submit a request (e.g., for a specific piece of content) and (b) receive a response (e.g., a requested piece of content). Such a facade may support possibly inter alia any combination of one or more of standards-based communication paradigms (such as possibly inter alia HTTP, etc.) and custom communication paradigms.

5. Director 714. A body of logic and a collection of flexible, extensible, and dynamically configurable rules, weightings, etc. that possibly inter alia (a) determine whether an application 704→708 request will be serviced or satisfied locally (from possibly inter alia information that is stored on the filesystem 722 of a device 702) or satisfied remotely (through possibly inter alia the communication capabilities 720 of a device 702) and (b) may optionally perform a range of parsing, substitution, mapping, etc. operations.

6. Communication Access Layer 716. A single consolidated interface through which possibly inter alia the communication capabilities 720 of a device 702 may be accessed. Such an interface may possibly inter alia expose or provide a single consistent API that may possibly inter alia hide or otherwise abstract away all of the complexities, differences, etc. that may exist across the universe of possible devices 702.

7. Filesystem Access Layer 718. A single consolidated interface through which possibly inter alia the filesystem 722 of a device 702 may be accessed. Such an interface may possibly inter alia expose or provide a single consistent API that may possibly inter alia hide or otherwise abstract away all of the complexities, differences, etc. that may exist across the universe of possible devices 702.

8. Device Communication 720. Communication capabilities that are provided by a device 702. Such capabilities may consist of possibly inter alia wireless (such as for example Global System for Mobile Communications [GSM], Code Division Multiple Access [CDMA], etc.), wired, infrared, NFC, etc. (724→726).

9. Device Filesystem 722. A filesystem provided by a device 702. Said filesystem 722 may possibly inter alia be exposed through aspects of an OS—such as for example Windows Mobile, Symbian, etc.—that is resident on a device 702. Said filesystem 722 may incorporate possibly inter alia any combination of one or more of flat space, a data structure (ranging from simple [such as for example list, tree, etc.] to complex [such as for example a database management system such as a RDBMS or an ODBMS]). Additionally said filesystem 722 may leverage possibly inter alia any combination of one or more of memory (such as for example Random Access Memory [RAM]), a disk drive (including for example a classic Hard Disk Drive [HDD] or a newer Solid State Drive [SSD]), etc.

To further illustrate aspects of the exemplary WD arrangement that was discussed above consider the following:

1) As Mary peruses, navigates, etc. content a Director 714 may employ any number of mechanisms to determine possibly inter alia where (i.e., from a local repository [such as 722] or from off the device [such as 720 via 716]) content should be secured. For example, a suite of dynamically configurable rules, preferences, etc. may select between a range of options (including possibly inter alia [a] when a device is online content is always be secured from off the device, [b] when a device is online content is secured from off the device only when the content is not available locally, [c] etc.).

2) As content is secured (e.g., as described in #1 above, during a synchronization operation, etc.) information (including possibly inter alia the content itself, updates to a resource visited list, updates to a content needed list, etc.) may be preserved in a local repository (such as 722). The contents of such a repository may optionally be managed through mechanisms such as aging models, periodic refresh, etc.

3) As Mary peruses, navigates, etc. content updates may be made to a resource visited list.

4) As Mary peruses, navigates, etc. content when a particular piece of content is unavailable (e.g., Mary's WD is offline) then any number of responses may be displayed (including possibly inter alia a ‘Resource Not Found’ message, a placeholder piece of content that is dynamically constructed based on various known criteria [e.g., such as other pages that may be available from a particular WWW site], etc.) and updates may be made to a content needed list.

The confirmation, response, etc. message(s) that were described above may optionally contain an informational element—e.g., a relevant or applicable factoid, etc. The informational element may be selected statically (e.g., all generated messages are injected with the same informational text), be selected randomly (e.g., a generated message is injected with informational text that is randomly selected from a pool of available informational text), or be location-based (i.e., a generated message is injected with informational text that is selected from a pool of available informational text based on the current physical location of the recipient of the message as derived from, as one example, a Location-Based Service [LBS] facility).

The confirmation, response, etc. message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), be selected randomly (e.g., a generated message is injected with advertising material that is randomly selected from a pool of available material), or be location-based (i.e., a generated message is injected with advertising material that is selected from a pool of available material based on the current physical location of the recipient of the message as derived from, as one example, a LBS facility).

The confirmation, response, etc. message(s) may optionally contain promotional materials (e.g., still images, video clips, etc.).

While aspects of the discussion that was presented above focused on web-based sources containing HTML documents it will be readily apparent to one of ordinary skill in the relevant art that other content sources (containing other resource types) are equally applicable and, indeed, are fully within the scope of the present invention.

It is important to note that while aspects of the discussion that was presented above focused on the use of SCs it will be readily apparent to one of ordinary skill in the relevant art that TNs and other message address identifiers are equally applicable and, indeed, are fully within the scope of the present invention.

The discussion that was just presented referenced the specific wireless messaging paradigms SMS and MMS. These paradigms potentially offer an incremental advantage over other paradigms (such as possibly inter alia Internet Protocol [IP] Multimedia Subsystem [IMS], IM, E-Mail, etc.) in that native support for SMS and/or MMS is commonly found on a WD that a potential MS would be carrying. However, it is to be understood that it would be readily apparent to one of ordinary skill in the relevant art that other paradigms are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| API | Application Programming Interface |
| AS | Application Server |
| AVI | Audio Video Interleave |
| BI | Billing Interface |
| CDMA | Code Division Multiple Access |
| CRC | Cyclic Redundancy Check |
| CSC | Common Short Code |
| DBMS | Database Management System |
| E-Mail | Electronic Mail |
| FTP | File Transfer Protocol |
| GIF | Graphics Interchange Format |
| GIS | Geographic Information System |
| GSM | Global System for Mobile Communications |
| GUCID | Globally Unique Content Identifier |
| GW | Gateway |
| HDD | Hard Disk Drive |
| HREF | HyperText Reference |
| HTML | HyperText Markup Language |
| HTTP | HyperText Transfer Protocol |
| IM | Instant Messaging |
| IMS | IP Multimedia Subsystem |
| IP | Internet Protocol |
| IQ | Incoming Queue |
| IVR | Interactive Voice Response |
| JPEG | Joint Photographic Experts Group |
| LBS | Location-Based Service |
| LS | Local System |
| MICV | Messaging Inter-Carrier Vendor |
| MMS | Multimedia Message Service |
| MPG | MPEG-1 |
| MP3 | MPEG-1 Audio Layer 3 |
| MS | Mobile Subscriber |
| NFC | Near Field Communication |
| ODBMS | Object Database Management System |
| OQ | Outgoing Queue |
| OS | Operating System |
| PC | Personal Computer |
| PDA | Personal Digital Assistant |
| PNG | Portable Network Graphics |
| RAM | Random Access Memory |
| RDBMS | Relational Database Management System |
| SAAS | Software as a Service |
| SC | Short Code |
| SMS | Short Message Service |
| SP | Service Provider |
| SSD | Solid State Drive |
| TN | Telephone Number |
| URL | Uniform Resource Locator |
| USB | Universal Serial Bus |
| WAV | Waveform Audio Format |
| WC | Wireless Carrier |
| WD | Wireless Device |
| WS | Web Server |
| WWW | World-Wide Web |
| XML | Extensible Markup Language |

What is claimed is:

1. A method for accessing content, comprising:
receiving from a wireless device of a mobile subscriber an indication of required content;
performing one or more processing steps, using (a) aspects of the indication of required content and (b) information about the mobile subscriber, to:
(a) retrieve content from one or more internal and/or external sources yielding retrieved content,
(b) process aspects of the retrieved content, including transforming links or references present in the retrieved content using Globally Unique Content Identifiers, yielding processed content, and
(c) persist aspects of the processed content yielding persisted content; and
delivering aspects of the persisted content to the wireless device.

2. The method of claim 1, wherein the information about the mobile subscriber comprises information that is defined by the mobile subscriber during a registration process.

3. The method of claim 2, wherein the registration process captures one or more of (a) Identifying Information, (b) Preference Information, and (c) Billing Information.

4. The method of claim 2, wherein the registration process results in a User Profile.

5. The method of claim 2, wherein the registration process is Web-based.

6. The method of claim 2, wherein the registration process includes a billing component.

7. The method of claim 1, wherein the process aspects of the retrieved content processing step employs an integer triple.

8. The method of claim 1, wherein (a) receiving from a wireless device of a mobile subscriber an indication of required content or (b) delivering aspects of the persisted content to the wireless device takes place during a synchronization operation.

9. The method of claim 8, wherein the synchronization operation includes one or more checkpoints.

10. The method of claim 8, wherein the synchronization operation includes one or more of (a) compression/decompression capabilities and (b) encryption/decryption capabilities.

11. The method of claim 8, wherein the synchronization operation includes a billing transaction.

12. A system for accessing content, comprising:
a gateway at which an indication of required content is received, the indication of required content having originated from a wireless device of a mobile subscriber;
at least one workflow module, the at least one workflow module being operable to:
(a) perform one or more processing steps, using (i) aspects of the indication of required content and (ii) information about the mobile subscriber, to (i) retrieve content from one or more internal and/or external sources yielding retrieved content, (ii) process aspects of the retrieved content, including transforming links or references present in the retrieved content using Globally Unique Content Identifiers, yielding processed content, and (iii) persist aspects of the processed content yielding persisted content; and
(b) deliver aspects of the persisted content to the wireless device.

13. The system of claim 12, wherein the information about the mobile subscriber comprises information that is defined by the mobile subscriber during a registration process.

14. The system of claim 12, wherein the process aspects of the retrieved content processing step employs an integer triple.

15. The system of claim 12, wherein (a) the indication of required content is received or (b) the deliver aspects of the persisted content to the wireless device step takes place during a synchronization operation.

16. The system of claim 15, wherein the synchronization operation includes one or more checkpoints.

17. The system of claim 15, wherein the synchronization operation includes one or more of (a) compression/decompression capabilities and (b) encryption/decryption capabilities.

18. The system of claim 15, wherein the synchronization operation includes a billing transaction.
